(19) United States
(12) Patent Application Publication
(10) Pub. No.: US 2024/0085987 A1
(43) Pub. Date: Mar. 14, 2024

(54) Environmentally Aware Gestures

(71) Applicant: Apple Inc., Cupertino, CA (US)

(72) Inventors: Dan Feng, Sunnyvale, CA (US); Anna Weinstein, Greenwood Village, CO (US)

(21) Appl. No.: 18/367,146

(22) Filed: Sep. 12, 2023

Related U.S. Application Data
(60) Provisional application No. 63/405,556, filed on Sep. 12, 2022.

(51) Int. Cl. G06F 3/01; G06T 13/40; G06V 40/20

(52) U.S. Cl. CPC G06F 3/017; G06T 13/40; G06V 40/20

(57) ABSTRACT

In one implementation, a method of presenting a scene is performed at a device including a display, one or more processors, and non-transitory memory. The method includes displaying, on the display, a virtual character in association with a physical environment at a character location in a three-dimensional coordinate system of the physical environment. The method includes determining, for an object, an object location in the three-dimensional coordinate system of the physical environment. The method includes displaying, on the display, the virtual character at the character location performing a gesture based on the object location.

### CROSS-REFERENCE TO RELATED APPLICATIONS

This application claims priority to U.S. Provisional Patent App. No. 63/405,556, filed on Sep. 12, 2022, which is hereby incorporated by reference in its entirety.

### TECHNICAL FIELD

The present disclosure generally relates to presenting a scene including a gesture in various extended reality (XR) environments.

### BACKGROUND

In various implementations, a scene includes virtual content to be presented in an XR environment based on a physical environment. In various implementations, the scene includes a gesture performed by a virtual character. It may be desirable to present the scene including the gesture in various different XR environments based on various different physical environments.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a physical environment with an electronic device surveying the physical environment.

FIGS. 2A-2F illustrate the electronic device of FIG. 1 displaying a graphical user interface (GUI) for composing a scene.

FIGS. 3A-3I illustrate the electronic device of FIG. 1 presenting the scene in a first XR environment based on a first physical environment.

FIGS. 4A-4I illustrate the electronic device of FIG. 1 presenting the scene in a second XR environment based on a second physical environment.

FIG. 5 is a flowchart representation of a method of presenting a scene in accordance with some implementations.

FIG. 6 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for presenting a scene. In various implementations, a method is performed at a device including a display, one or more processors, and non-transitory memory. The method includes displaying, on the display, a virtual character in association with a physical environment at a character location in a three-dimensional coordinate system of the physical environment. The method includes determining, for an object, an object location in the three-dimensional coordinate system of the physical environment. The method includes displaying, on the display, the virtual character at the character location performing a gesture based on the object location.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various implementations, a scene including virtual content is presented in various different XR environments based on various different physical environments with different physical characteristics, such as different sets of physical objects present in the physical environment. In various implementations, the scene includes a gesture performed by a virtual character. Described below are methods and systems for presenting the scene including the gesture in various different XR environments.

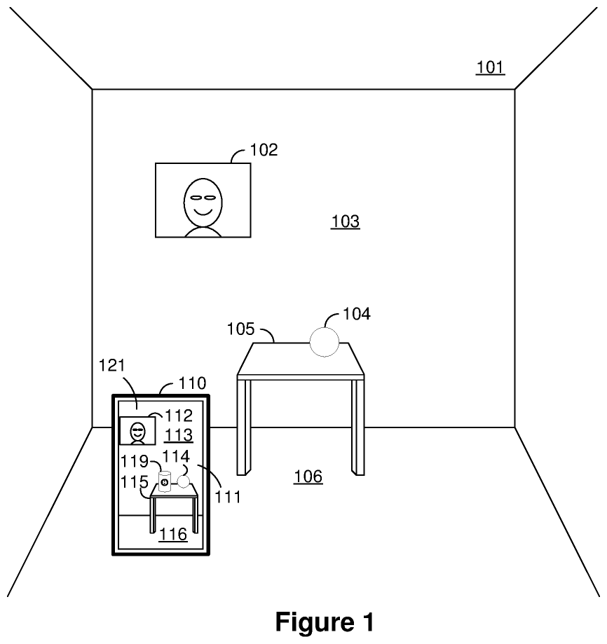

FIG. 1 illustrates a physical environment 101 with an electronic device 110 surveying the physical environment 101. The physical environment 101 includes a picture 102 hanging on a wall 103, a table 105 on a floor 106, and a ball 104 on the table 105.

The electronic device 110 displays, on a display, an image of an XR environment 121 which includes a representation of the physical environment 111 and a representation of a virtual object 119. In various implementations, the representation of the physical environment 111 is generated based on an image of the physical environment 101 captured with one or more cameras of the electronic device 110 having a field-of-view directed toward the physical environment 101. Suitable cameras include scene cameras, event cameras, depth cameras, and so forth. Accordingly, the representation of the physical environment 111 includes a representation of the picture 112 hanging on a representation of the wall 113, a representation of the table 115 on a representation of the floor 116, and a representation of the ball 114 on the representation of the table 115.

In addition to the representations of real objects of the physical environment 101, the image of the XR environment 121 includes a representation of the virtual object 119. The visual appearance of the virtual object 119 is defined by software on the electronic device 110. The electronic device 110 presents the virtual object 119 as resting on the top surface of the representation of the table 115 by accounting for the position and orientation of device 110 relative to table 105.

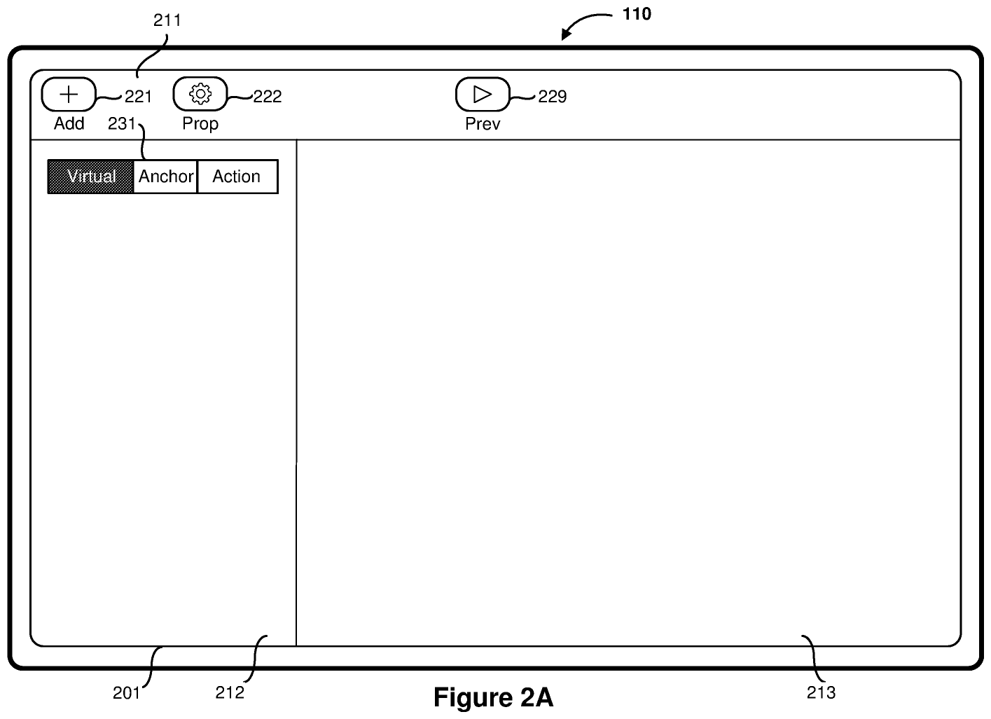

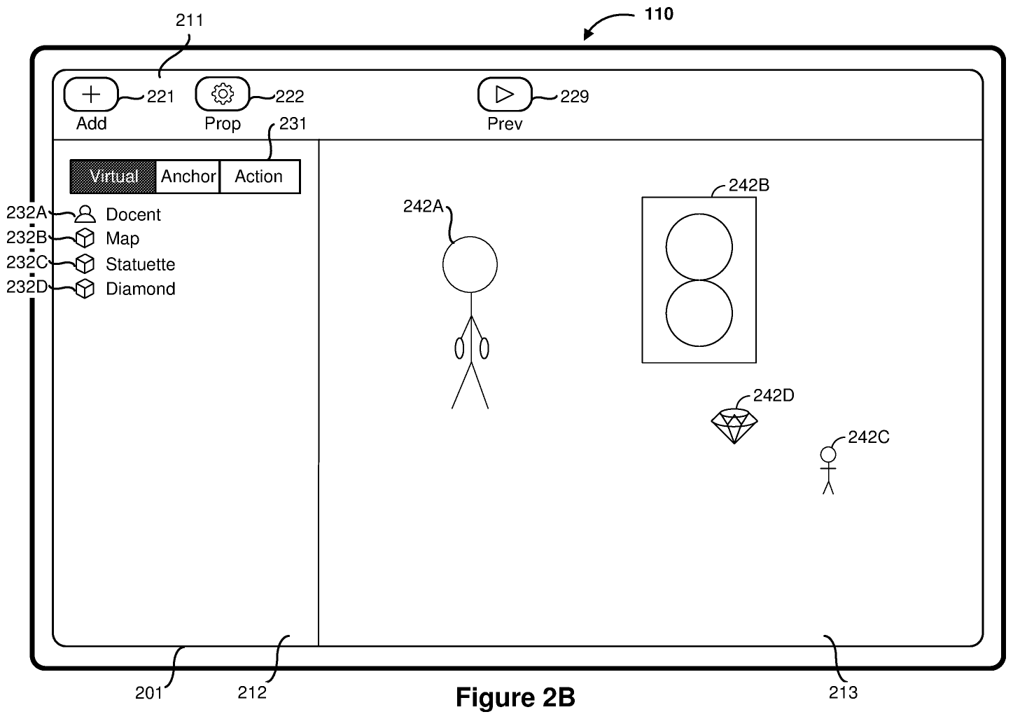

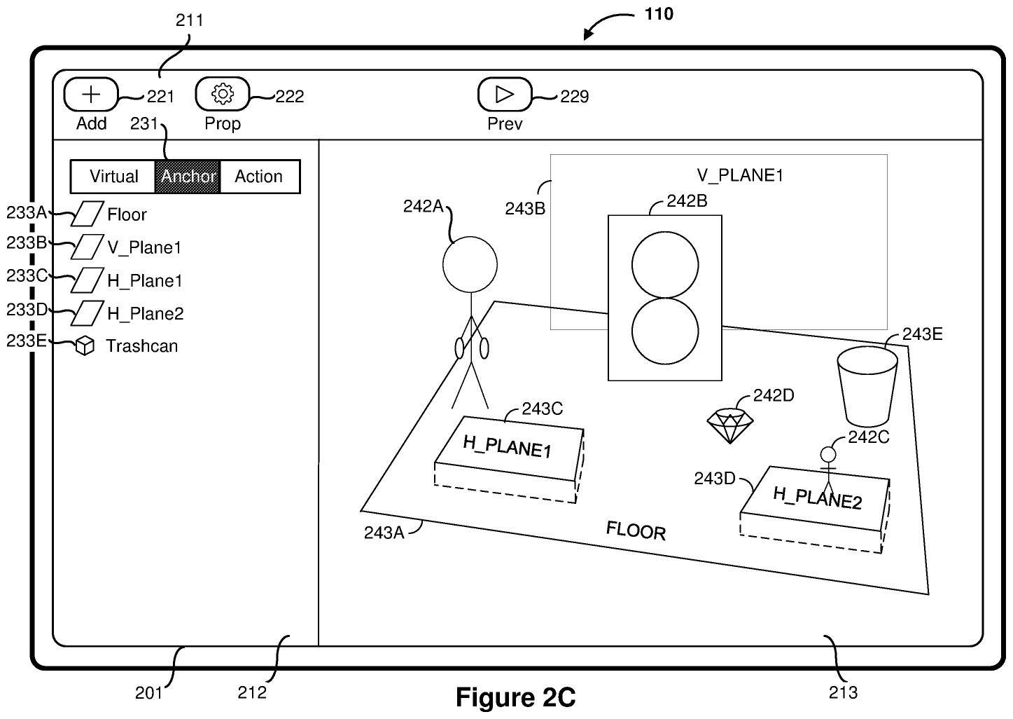

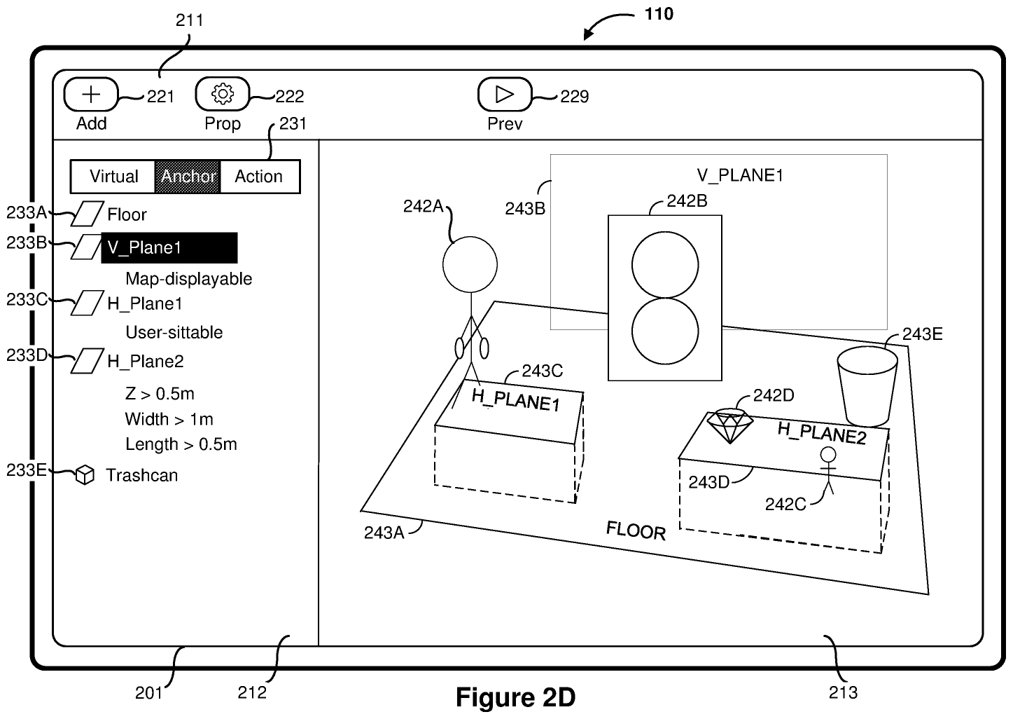

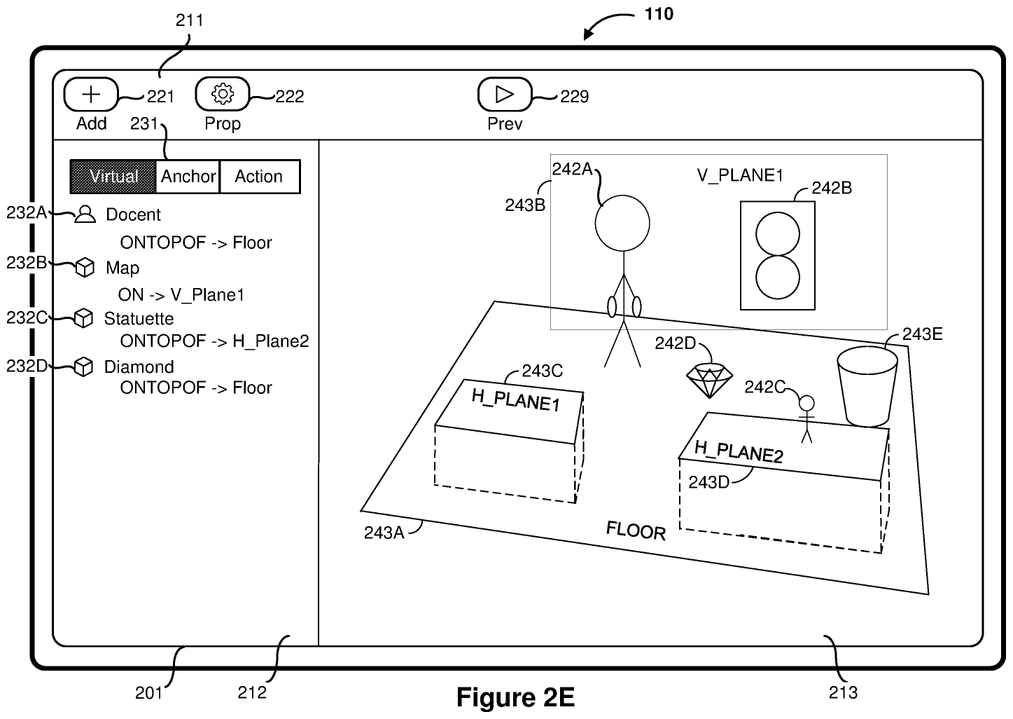

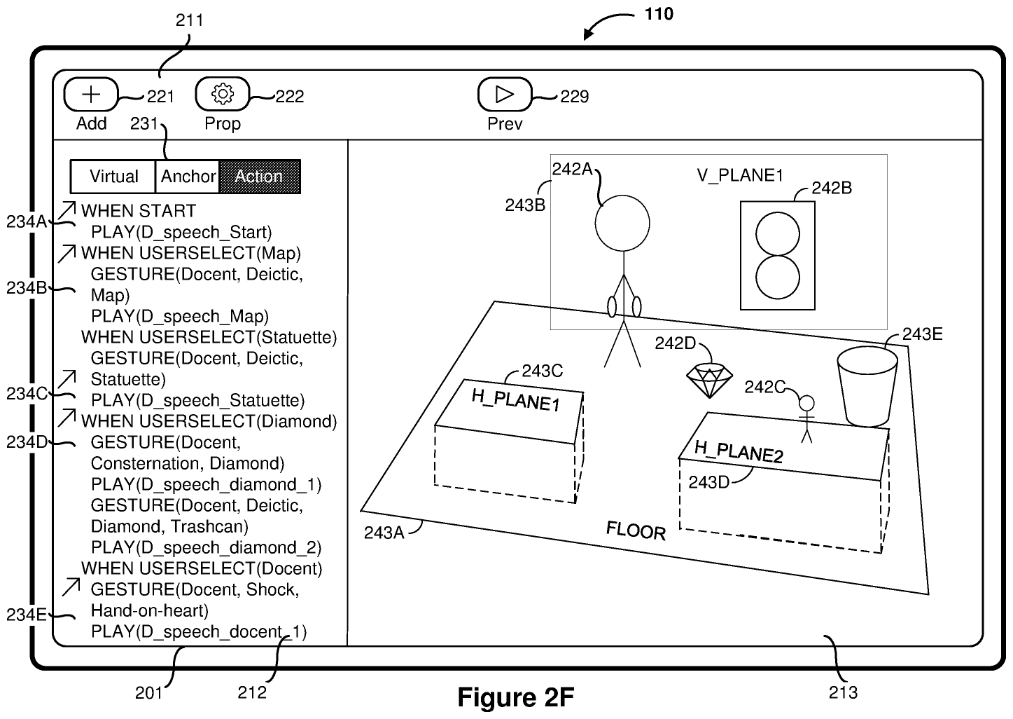

FIG. 2A illustrates the electronic device 110 displaying a graphical user interface (GUI) 201 for composing a scene. In particular, the GUI 201 includes a representation of the scene. In various implementations, an application of the electronic device 110 or a different electronic device executes to present the scene in an XR environment, such as a virtual environment or in association with a representation of a physical environment.

The GUI 201 includes a toolbar region 211, an assets region 212, and a view region 213. The toolbar region 211 includes an asset addition affordance 221 for adding assets to the scene, a properties affordance 222 for manipulating properties of selected assets, and a preview affordance 229 for previewing the scene in a physical environment of the electronic device 110.

The assets region 212 includes a list of assets associated with the scene. The assets associated with the scene include virtual assets, anchor assets, and action assets. In various implementations, the assets region 212 includes an asset type selection affordance 231 for selecting which type of asset is listed in the assets region 212, e.g., a list of virtual assets, a list of anchor assets, or a list of action assets.

The view region 213 includes a representation of the scene. In various implementations, the representation of the scene includes representations of the virtual assets associated with the scene. In various implementations, the representation of the scene includes representations of the anchor assets associated with the scene. In various implementations, the representation of the scene includes representations of the action assets associated with the scene.

In various implementations, a virtual asset associated with the scene includes a description of virtual content which is displayed in association with a physical environment when the scene is executed. In various implementations, a virtual asset includes a description of one or more virtual objects. In various implementations, a virtual asset includes a description of a virtual character, which may also be referred to as a virtual objective-effectuator. In various implementations, a virtual character receives objectives and determines actions to achieve those objectives, wherein each of the actions is associated with an animation or animation heuristic of the virtual character such that the virtual character is displayed performing the action. For example, in various implementations, the objective for a virtual dog character may be to hold a virtual bone on a physical floor. To achieve the objective, the virtual dog character determines a series of actions of jumping off a physical couch onto the physical floor (associated with a jump-down animation), walking along the physical floor to a location of the virtual bone (associated with a walking animation), and picking up the virtual bone (associated with a pick-up animation).

In various implementations, an anchor asset associated with the scene includes a description of an object which may or may not be present in an environment. In particular, in various implementations, an anchor asset includes a description of at least one object criteria which may be met by a physical object in a physical environment or by a virtual object in a virtual environment. For example, in various implementations, an anchor asset includes a description of a horizontal plane at a particular height and of a particular width. In various implementations, the anchor asset corresponds to the top of a physical table in a first physical environment and the top of a physical desk in a second physical environment. In various implementations, the anchor asset corresponds to a virtual stool in a first virtual environment and a virtual chair in a second virtual environment.

In various implementations, an action asset associated with the scene includes a description of an action which is performed in response to a trigger. In various implementations, the action includes a gesture performed by a virtual character. In various implementations, the actions include movement of a virtual object, playing audio, changing a lighting condition, etc.

In FIG. 2A, the asset type selection affordance 231 indicates that virtual assets are listed in the assets region 212. In FIG. 2A, the scene is not yet associated with any assets. Accordingly, the assets region 212 and the view region 213 is empty.

FIG. 2B illustrates the GUI 201 of FIG. 2A in response to the user adding a number of virtual assets to the scene, e.g., by interacting with the asset addition affordance 221 while the asset type selection affordance 231 has virtual assets selected and providing additional user input. In various implementations, the additional user input includes selecting the virtual objects from a library of virtual content. The virtual assets added to the scene include a virtual docent character, a virtual map, a virtual statuette, and a virtual diamond. Accordingly, the assets region 212 includes a text representation of the virtual docent character 232A, a text representation of the virtual map 232B, a text representation of the virtual statuette 232C, and a text representation of the virtual diamond 232D. Further, the view region 213 includes a graphical representation of the virtual docent character 242A, a graphical representation of the virtual map 242B, a graphical representation of the virtual statuette 242C, and a graphical representation of the virtual diamond 242D.

FIG. 2C illustrates the GUI 201 of FIG. 2B in response to the user adding a number of anchor assets to the scene, e.g., by interacting with the asset addition affordance 221 while the asset type selection affordance 231 has anchor assets selected and providing additional user input. In various implementations, the additional user input includes selecting the anchor assets from a library of characteristics that may be present in various environments. In various implementations, the characteristics include surfaces, such as a plane. In various implementations, the characteristics include a horizontal plane or a vertical plane. In various implementations, the characteristics include a floor, a wall, or a ceiling. In various implementations, the characteristics include objects, such as a chair, a trashcan, a baseball, etc. In various implementations, the characteristics include environmental characteristics, such as temperature, humidity, ambient lighting conditions, location, or time-of-day.

The anchor assets added to the scene include an anchor floor, an anchor vertical plane, a first anchor horizontal plane, a second anchor horizontal plane, and an anchor trashcan. Accordingly, the assets region 212 includes a text representation of the anchor floor 233A, a text representation of the anchor vertical plane 233B, a text representation of the first anchor horizontal plane 233C, a text representation of the second anchor horizontal plane 233D, and a text representation of the anchor trashcan 233E. Further, the view region 213 includes a graphical representation of the anchor floor 243A, a graphical representation of the anchor vertical plane 243B, a graphical representation of the first anchor horizontal plane 243C, a graphical representation of the second anchor horizontal plane 243D, and a graphical representation of the anchor trashcan 243E.

FIG. 2D illustrates the GUI of FIG. 2C in response to the user adding a number of properties to the anchor assets of the scene, e.g., by interacting with the property affordance 222 while particular anchor assets are selected and providing additional user input. For example, the user has added a first property to the anchor vertical plane that it is map-displayable. The first property indicates that anchor vertical plane is capable of having displayed thereupon the virtual map. Similarly, the first property indicates that the virtual map is capable of being (including, in various implementations, allowed to be) displayed upon the anchor vertical plane. In various implementations, the property of being map-displayable is defined by the user of the GUI 201, defined by the creator of the virtual map, or defined by the creator of the GUI 201. In various implementations, the property of being map-displayable is defined as a function of various criteria. For example, in various implementations, the criteria include a height value and a width value being within particular ranges. In various implementations, the criteria include being associated with an object having one of a particular set of object types (e.g., “WALL”). In various implementations, the criteria include being of a uniform color. In various implementations, the criteria include being designated as map-displayable by a user after detection of the vertical plane. In various implementations, the function of the various criteria is that all the defined criteria must be met for a vertical plane to be determined as map-displayable. In various implementations, the function of the various criteria does not require that all the defined criteria be met. For example, in various implementations, a vertical plane is determined as map-displayable if (1) it is of a uniform color and (2A) it is associated with an object type of “WALL” or (2B) its height value and width value are greater than particular thresholds. Thus, as an example, an electronic device detects a wall as a vertical plane, assigns the vertical plane an object type of “WALL”, determines that the vertical plane is of a uniform color (e.g., not covered with pictures, posters, or other patterns), and, therefore, determines that the vertical plane is map-displayable. Further, as another example, an electronic device detects the writing surface of a rollaway whiteboard (or the canvas of a blank painting upon an easel) as a vertical plane, detects the whiteboard and assigns it an object type other than “WALL” (e.g., “PARTITION” or “VERTICAL-OTHER”), determines that the height and width of the vertical plane are within particular ranges, determines that the vertical plane is of a uniform color (e.g., not covered with pictures, posters, or other patterns), and, therefore, determines that the vertical plane is map-displayable.

As another example, the user has added a first property to the first anchor horizontal plane that it is user-sittable. The first property indicates that the first anchor horizontal plane is capable of being sat upon by a user being presented the scene. Similarly, the first property indicates that the user is capable of sitting upon the first anchor horizontal plane. In various implementations, the property of being user-sittable is defined by the user of the GUI 201 or defined by the creator of the GUI 201. In various implementations, the property of being user-sittable is defined as a function of various criteria. For example, in various implementations, the criteria include a height value, length value, and width value being within particular ranges. In various implementations, the criteria include being associated with an object having one of a particular set of object types (e.g., “CHAIR”, “STOOL”, “SOFA”, etc.). In various implementations, the criteria include being designated as user-sittable by the user after detection of the horizontal plane. In various implementations, the function of the various criteria is that all the defined criteria must be met for a horizontal plane to be determined as user-sittable. In various implementations, the function of the various criteria does not require that all the defined criteria be met. For example, in various implementations, a horizontal plane is determined as user-sittable if (1) it is associated with an object type of “CHAIR” or (2) its height value, length value, and width value are within particular ranges and the user designates the horizontal plane as user-sittable after detection of the horizontal plane having the height value, length value, and width value within the particular ranges. Thus, as an example, an electronic device detects the seat of a chair as a horizontal plane, detects the chair and assigns it an object type of “CHAIR”, and determines that the horizontal plane is user-sittable. Further, as another example, an electronic device detects the top of a flat rock as a horizontal plane, detects the rock and assigns it an object type of “ROCK” (and does not assign it an object type of “CHAIR”), determines that the height, length, and width of the horizontal plane are within particular ranges, requests that the user designate the horizontal plane as user-sittable and, in response to an affirmative response from the user, determines that the horizontal plane is user-sittable.

Further, the user has added a first property to the second anchor horizontal plane that its height value is above 0.5 meters, a second property to the second anchor horizontal plane that its width value is above 1 meter, and a third property to the second anchor horizontal plane that is length value is above 0.5 meters.

Accordingly, in the asset region 212, text representations of the properties are displayed in respective association with the text representation of the anchor assets. Further, in the view region 213, the graphical representations of the anchor assets are modified based on the properties. For example, the graphical representation of the second anchor horizontal plane 243D is displayed with a height value, width value, and length value satisfying the properties.

FIG. 2E illustrates the GUI 201 of FIG. 2D in response to the user adding a number of properties to the virtual assets of the scene, e.g., by interacting with the property affordance 222 while particular virtual assets are selected and providing additional user input. For example, the user has added a first property to the virtual docent character that it is on top of the anchor floor. The user has added a first property to the virtual map that it is on the anchor vertical plane. The user has added a first property to the virtual statuette that is on the second anchor horizontal plane. The user has added a first property to the virtual diamond stack that is on the anchor floor.

Accordingly, in the asset region 212, text representations of the properties are displayed in respective association with the text representation of the virtual assets. Further, in the view region 213, the graphical representations of the virtual assets are modified based on the properties. For example, the graphical representation of the virtual map 242B is displayed on the graphical representation of the anchor vertical plane 243B. As another example, the graphical representation of the virtual statuette 242C is displayed on the graphical representation of the second anchor horizontal plane 243D.

FIG. 2F illustrates the GUI 201 of FIG. 2E in response to the user adding a number of action assets to the scene, e.g., by interacting with the asset addition affordance 221 while the while the asset type selection affordance 231 has action assets selected and providing additional user input.

The action assets include a first action asset illustrated by the text representation of the first action asset 234A. The first action asset describes an action that is triggered at when the scene is first presented, e.g., at the start of the scene. The first action asset includes the virtual docent character giving an introductory speech, which may include both audio and animation of the virtual docent character. Animation of the virtual docent character can include the virtual character performing one or more gestures, such as deictic gestures, beat gestures, etc.

The action assets include a second action asset illustrated by the text representation of the second action asset 234B. The first action asset describes an action that is triggered by the user indicating the virtual map (e.g., by pointing at a representation of the virtual map) and includes the virtual docent character performing a deictic gesture indicating the virtual map and giving a speech describing the virtual map, which may include both audio and animation of the virtual docent character.

The action assets include a third action asset illustrated by the text representation of the third action asset 234C. The third action asset describes an action that is triggered by the user indicating the virtual statuette (e.g., by pointing at a representation of the virtual statuette) and includes the virtual docent character performing a deictic gesture indicating the virtual statuette and giving a speech describing the virtual statuette, which may include both audio and animation of the virtual docent character.

The action assets include a fourth action asset illustrated by the text representation of the fourth action asset 234D. The fourth action asset describes an action that is triggered by the user indicating the virtual diamond (e.g., by pointing at a representation of the virtual diamond) and includes the virtual docent character initially (1) performing a consternation gesture directed at the virtual diamond and giving a speech regarding a location of the virtual diamond, which may include both audio and animation of the virtual docent character and, thereafter (2) performing a deictic gesture indicating the virtual diamond and the object in the environment corresponding to the anchor trashcan and giving a speech regarding an authenticity of the virtual diamond, which may include both audio and animation of the virtual docent character.

The action assets include a fifth action asset partially illustrated by the text representation of the fifth action asset 235D. The fifth action asset describes an action that is triggered by the user indicating the virtual docent character (e.g., by pointing at a representation of the virtual docent character) and includes the virtual docent character initially (1) performing a shock gesture including placing the virtual docent character's hand over the virtual docent character's heart and giving a speech expressing shock at being selected, which may include both audio and animation of the virtual docent character and, thereafter (2) performing a deictic gesture indicating the user and giving a speech regarding interest in the user, which may include both audio and animation of the virtual docent character.

The action assets include a sixth action asset (not shown in FIG. 2F) that is triggered after the user has selected the virtual map, the virtual statuette, and the virtual diamond, e.g., after the second action, the third action, and the fourth action have been performed. The sixth action asset includes the virtual docent character performing a deictic gesture indicating the object in the environment corresponding to the first anchor horizontal plane and giving a speech requesting that the user sit, which may include both audio and animation of the virtual docent character.

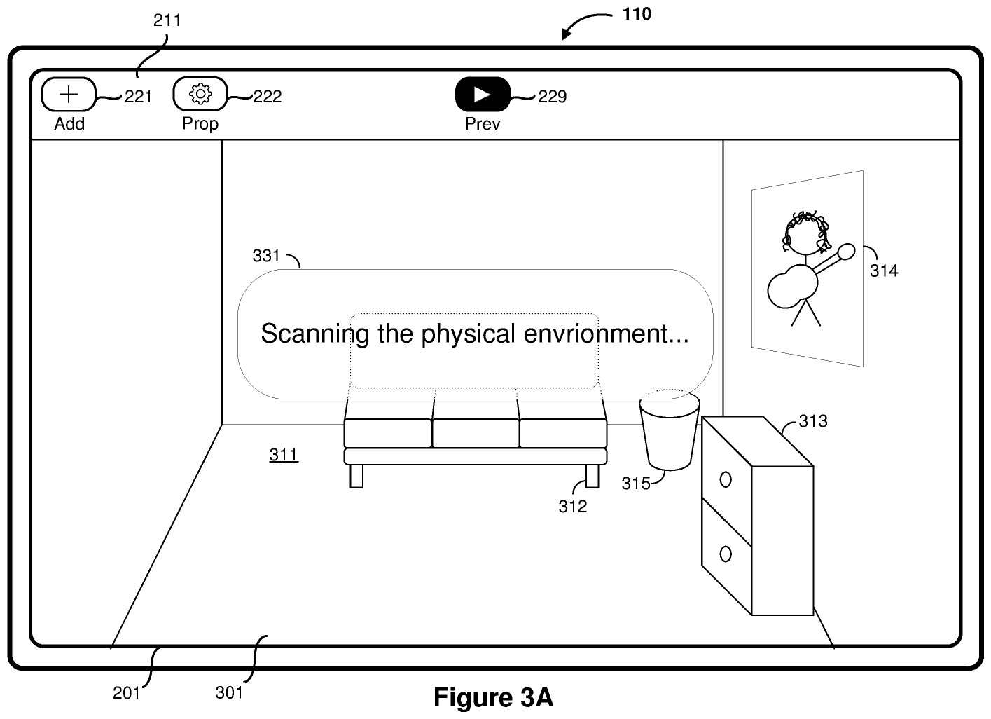

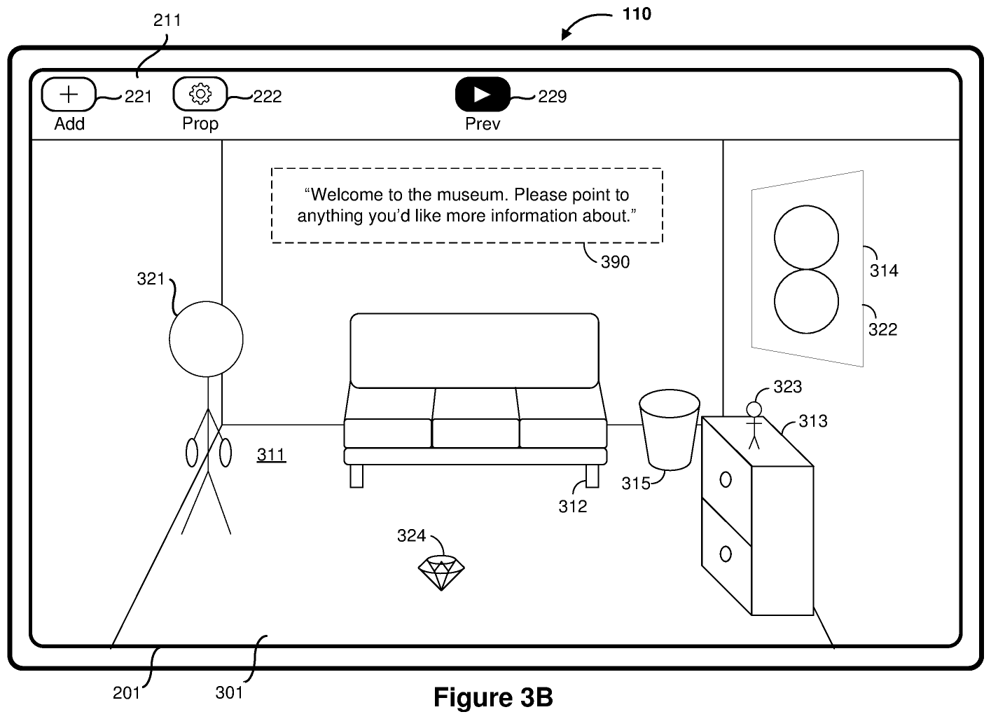

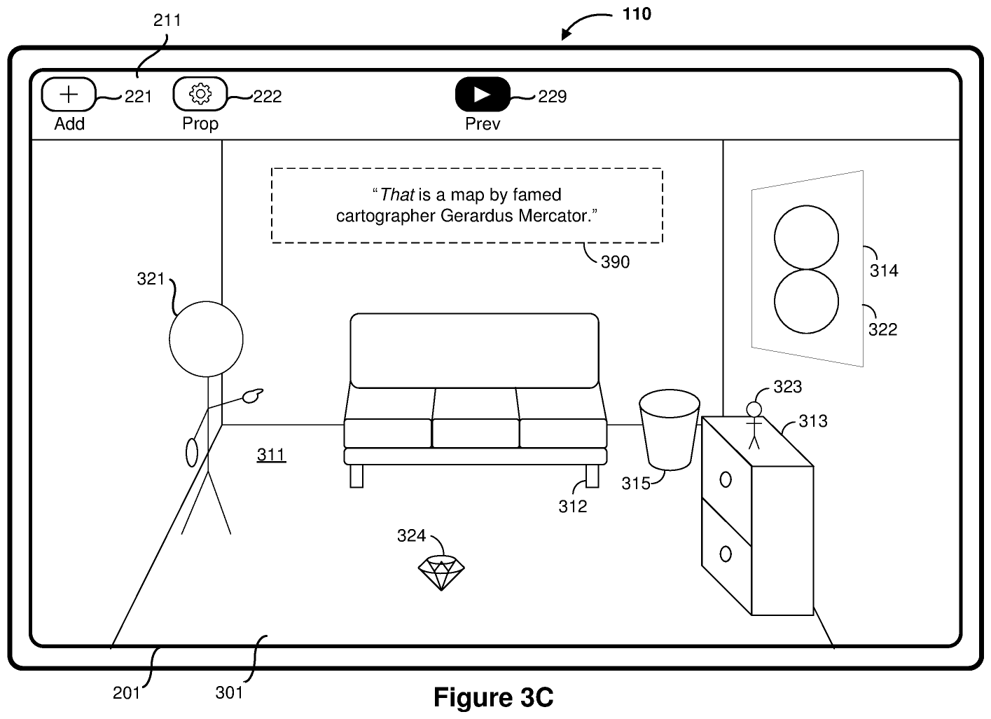

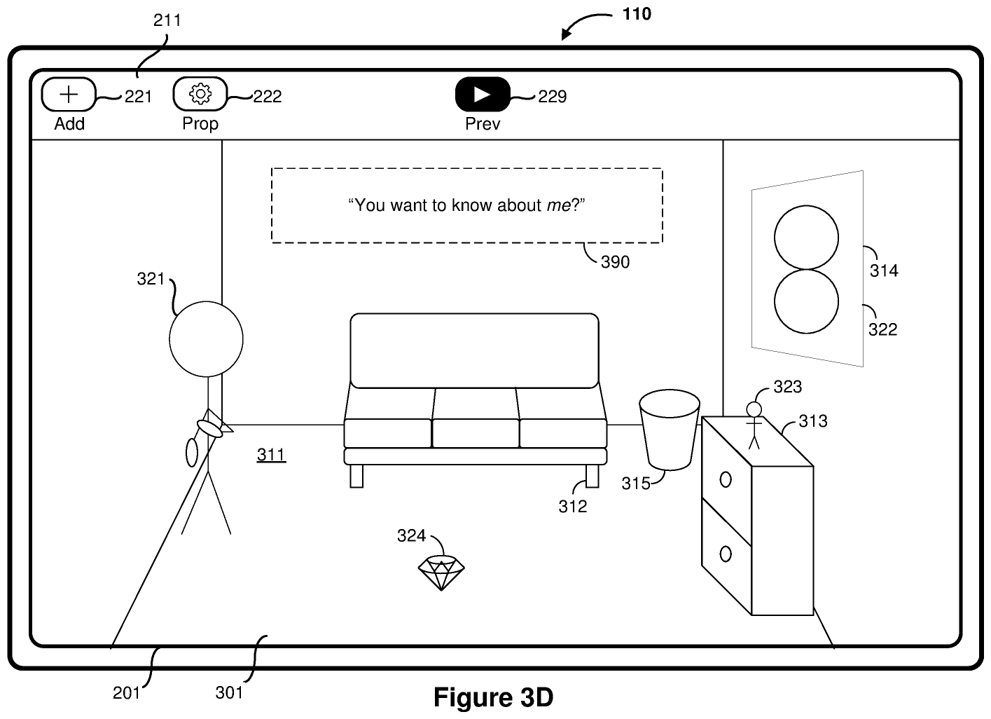

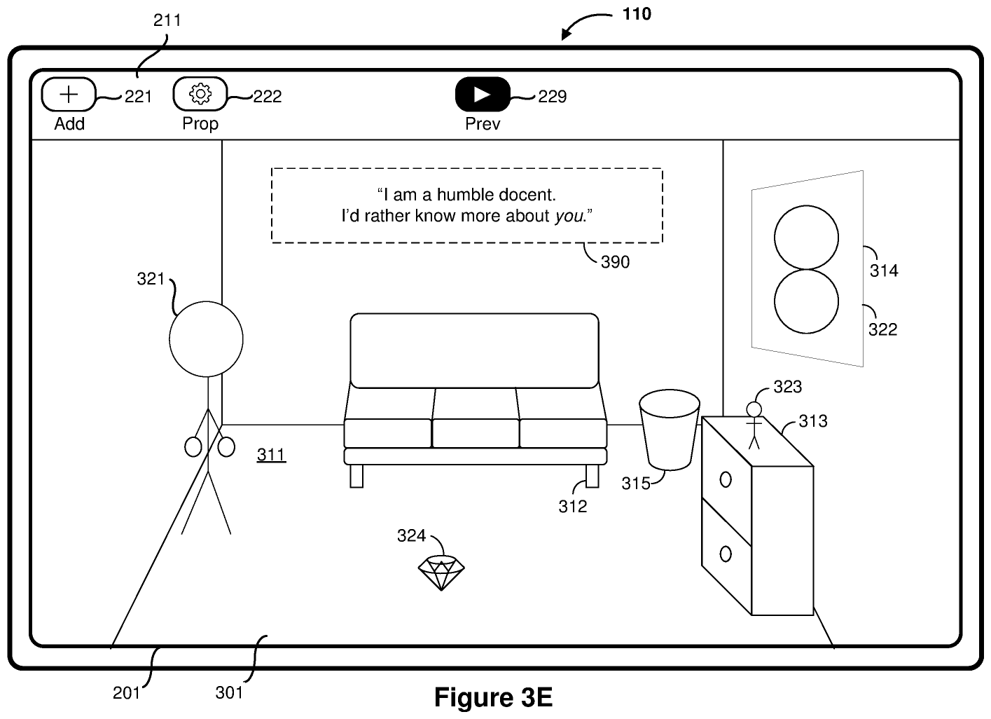

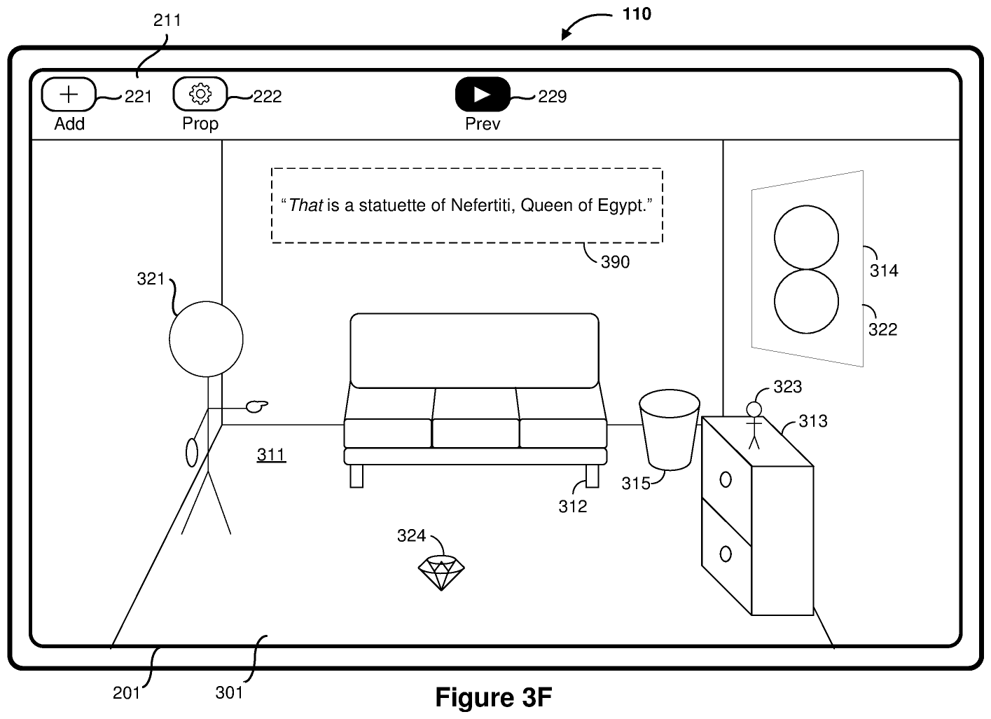

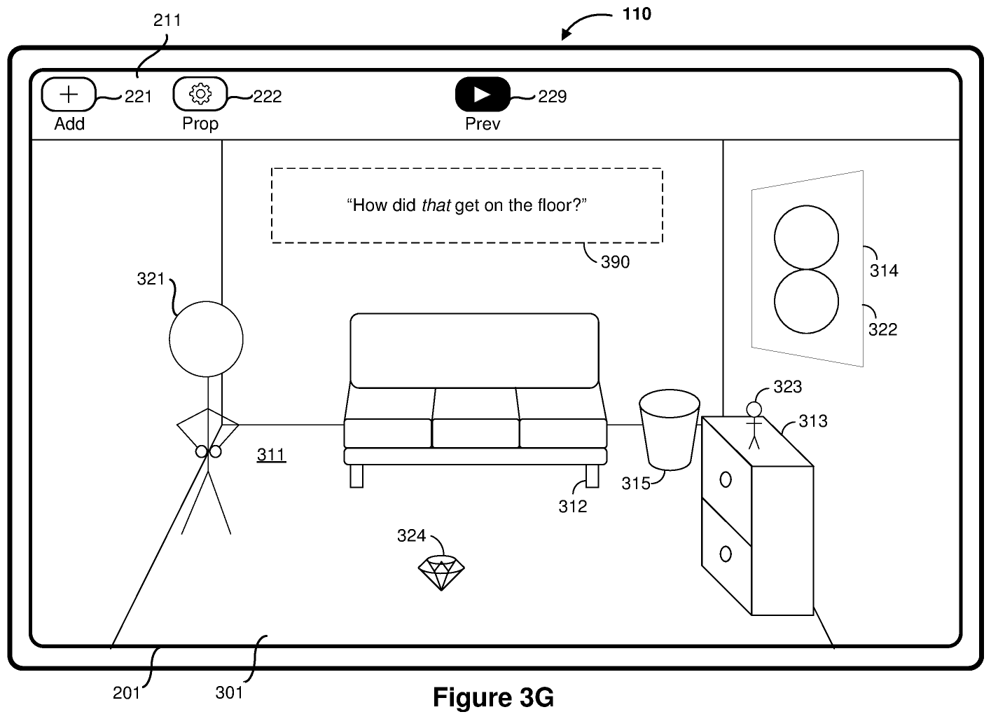

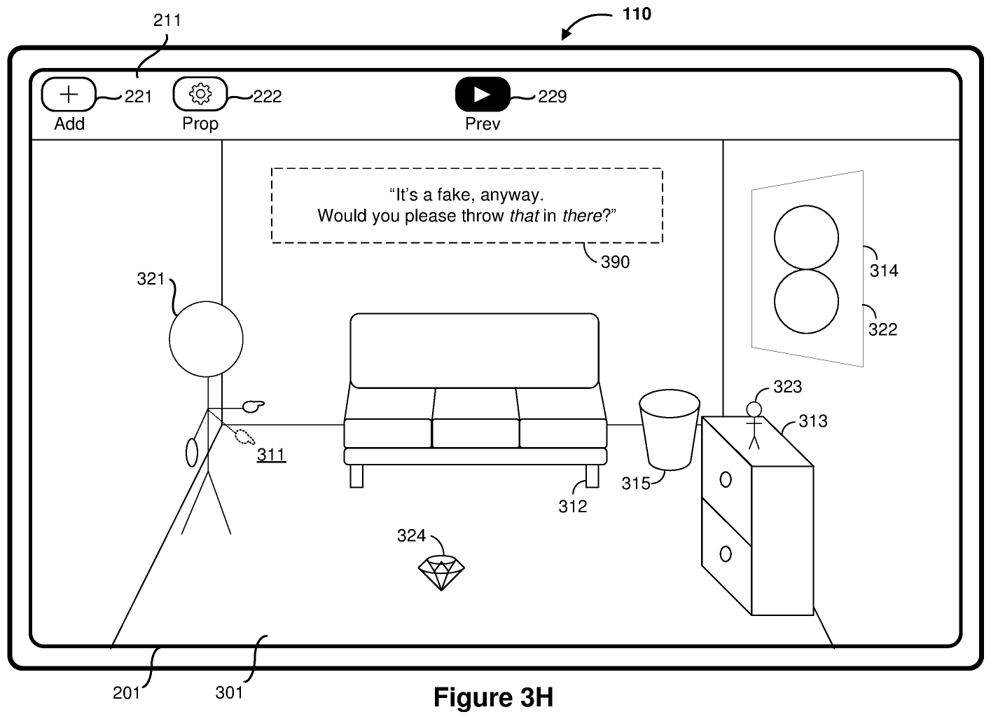

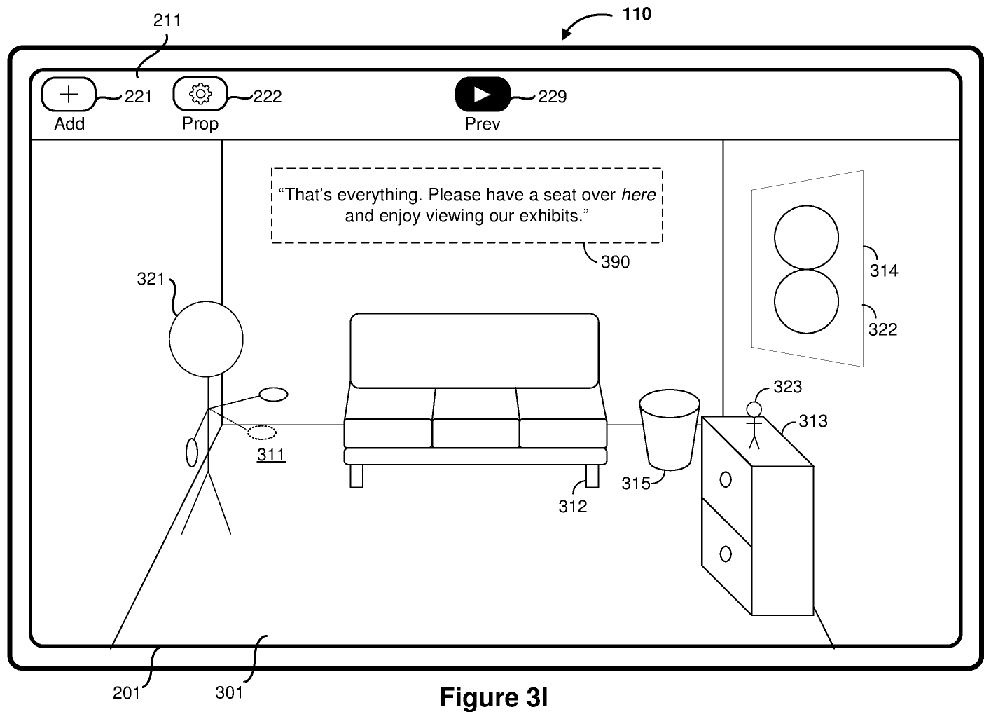

FIGS. 3A-3I illustrate a preview of the scene in a first physical environment in which the electronic device 110 is present. In various implementations, the preview of the scene is displayed in response to the user selecting the preview affordance 229 while in the first physical environment.

FIG. 3A illustrates the GUI 201 of FIG. 2F in response to detecting a user input directed to the preview affordance 229 while in a first physical environment. In FIG. 3A, the assets region 212 and the view region 213 are replaced with a preview region 301 providing a preview of the scene.

The first physical environment includes a physical wood floor, a physical couch, a physical dresser, a physical poster, and a physical wastebasket. Accordingly, the preview region 301 includes a representation of the first physical environment including a representation of the physical wood floor 311, a representation of the physical couch 312, a representation of the physical dresser 313, a representation of the physical poster 314, and a representation of the physical wastebasket 315.

In providing the preview of the scene, the electronic device 110 scans the first physical environment to determine whether the first physical environment includes physical objects that correspond to the anchor assets of the scene with the properties of the anchor assets. While doing so, the electronic device 110 displays a scanning notification 331.

In the first physical environment, the electronic device 110 determines that the physical wood floor corresponds to the anchor floor, that the physical poster is blackboard-displayable and corresponds to the anchor vertical plane, that the top of the physical dresser has the appropriate size and location properties and corresponds to the second anchor horizontal plane, that the physical wastebasket corresponds to the anchor trashcan, and that the physical couch is professor-sittable and corresponds to the first anchor horizontal plane.

FIG. 3B illustrates the GUI 201 of FIG. 3A in response to determining that the first physical environment includes an object that corresponds to each anchor asset of the scene with the properties of the anchor asset.

In executing the scene, the preview region 301 includes a representation of the virtual map 322 displayed over the representation of the physical poster 314, a representation of the virtual docent character 321 displayed on the representation of the physical wood floor 311, a representation of the virtual statuette 323 on top of the representation of the physical dresser 313, and a representation of the virtual diamond 324 on top of the representation of the physical wood floor 311.

Further, the preview region 301 includes the virtual docent character giving the introductory speech. In various implementations, the preview region 301 includes a speech indicator 390 as a display-locked virtual object corresponding to audio produced by the electronic device 110. For example, at the time illustrated in FIG. 3B, the electronic device 110 produces the sound of the virtual docent character saying “Welcome to the museum. Please point to anything you′d like more information about,” e.g., the introductory speech. Although FIG. 3B (and FIGS. 3C-3I) illustrates the speech indicator 390 as a display-locked virtual object, in various implementations, the speech indicator 390 is not displayed while the audio is produced by the electronic device 110.

FIG. 3C illustrates the GUI 201 of FIG. 3B in response to the user pointing at the representation of the virtual map 322. In FIG. 3C, the virtual docent character performs a deictic gesture indicating the representation of the virtual map 322, e.g., performing a pointing gesture at the representation of the virtual map 322. In various implementations, a pointing gesture indicating a target includes a hand having an extended index finger having a tip and one or more joints generally collinear with the location of the target and the rest of the fingers flexed. In FIG. 3C, the virtual docent character performs a speech regarding the virtual map. Accordingly, in FIG. 3C, the speech indicator 390 includes the phrase “That is a map by famed cartographer Gerardus Mercator.”

FIG. 3D illustrates the GUI 201 of FIG. 3C in response to the user pointing at the representation of the virtual docent character 321. In FIG. 3D, the virtual docent character performs a shock gesture including placing the virtual docent character's hand over the virtual docent character's heart. In FIG. 3D, the virtual docent character performs a speech expressing shock at being selected. Accordingly, in FIG. 3D, the speech indicator 390 includes the phrase “You want to know about me?”

FIG. 3E illustrates the GUI of FIG. 3D after the virtual docent character concludes performing the speech expressing shock at being selected. In FIG. 3E, the virtual docent character performs a deictic gesture indicating the user, e.g., performing a showing gesture towards the user. In various implementations, a showing gesture indicating a target includes one or two hands open with the palms facing up, one or more of the fingers having a tip and one or more joints generally collinear with the location of the target. In FIG. 3E, the virtual docent character performs a speech expressing interest in the user. Accordingly, in FIG. 3E, the speech indicator 390 includes the phrase “I am a humble docent. I'd rather know more about you.”

FIG. 3F illustrates the GUI of FIG. 3E in response to the user pointing at the representation of the virtual statuette 323. In FIG. 3F, the virtual docent character performs a deictic gesture indicating the representation of the virtual statuette 323, e.g., performing a pointing gesture at the representation of the virtual statuette 323. In FIG. 3F, the virtual docent character performs a speech regarding the virtual statuette. Accordingly, in FIG. 3F, the speech indicator 390 includes the phrase “That is a statuette of Nefertiti, Queen of Egypt.”

FIG. 3G illustrates the GUI of FIG. 3F in response to the user pointing at the representation of the virtual diamond 324. In FIG. 3G, the virtual docent character performs a consternation gesture directed at the representation of the virtual diamond 324. In various implementations, a consternation gesture includes placing each hand on a respective hip, either open or closed. In various implementations, the consternation gesture further includes a facial expression of consternation. In FIG. 3G, the virtual docent character performs a speech regarding a location of the virtual diamond. Accordingly, in FIG. 3G, the speech indicator 390 includes the phrase “How did that get on the floor?”

FIG. 3H illustrates the GUI of FIG. 3G after the virtual docent character concludes performing the speech regarding the location of the virtual diamond. In FIG. 3H, the virtual docent character performs a deictic gesture indicating the representation of the virtual diamond 324 and the representation of the physical wastebasket 315, e.g., performing a pointing gesture at the representation of the virtual diamond 324 followed by a motion of the arm, without motion of the hand, to perform a pointing gesture at the representation of the physical wastebasket 315. In FIG. 3E, the virtual docent character performs a speech regarding the authenticity of the virtual diamond. Accordingly, in FIG. 3H, the speech indicator 390 includes the phrase “It's a fake, anyway. Would you please throw that in there?”

FIG. 3I illustrates the GUI of FIG. 3H in response to having performed the second action, the third action, and the fourth action. In FIG. 3I, the virtual docent character performs a deictic gesture indicating the representation of the physical couch 312, e.g., performing a showing gesture sweeping from a first location of the representation of the physical couch 312 to a second location of the representation of the physical couch 312. In FIG. 3I, the virtual docent character performs a speech inviting the user to sit. Accordingly, in FIG. 3I, the speech indicator 390 includes the phrase “That's everything. Please have a seat over here and enjoy viewing our exhibits.”

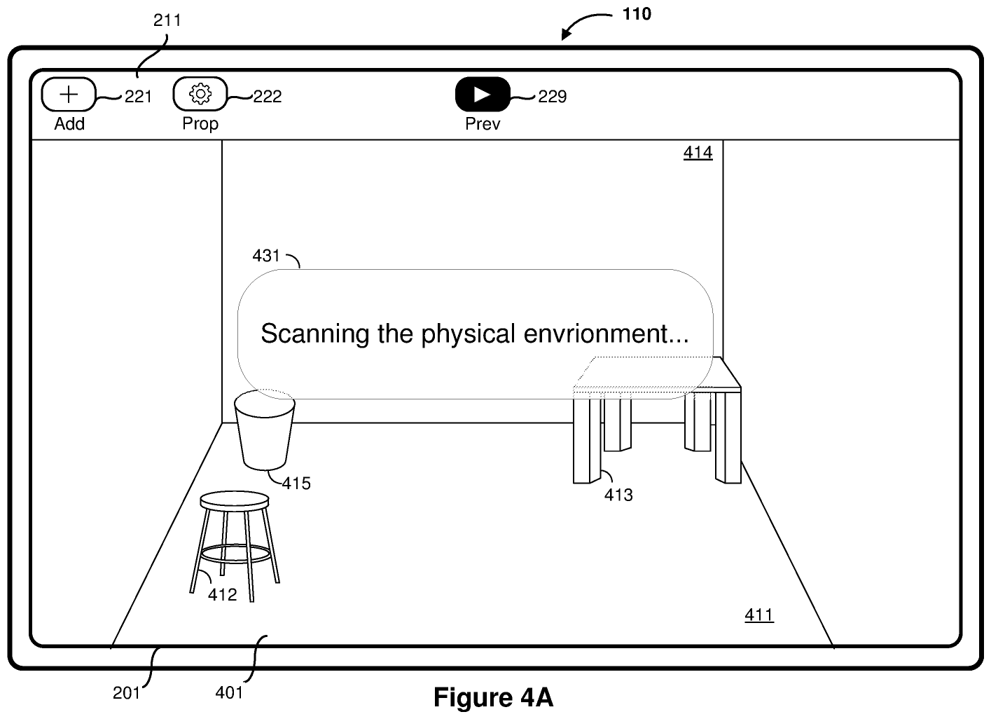

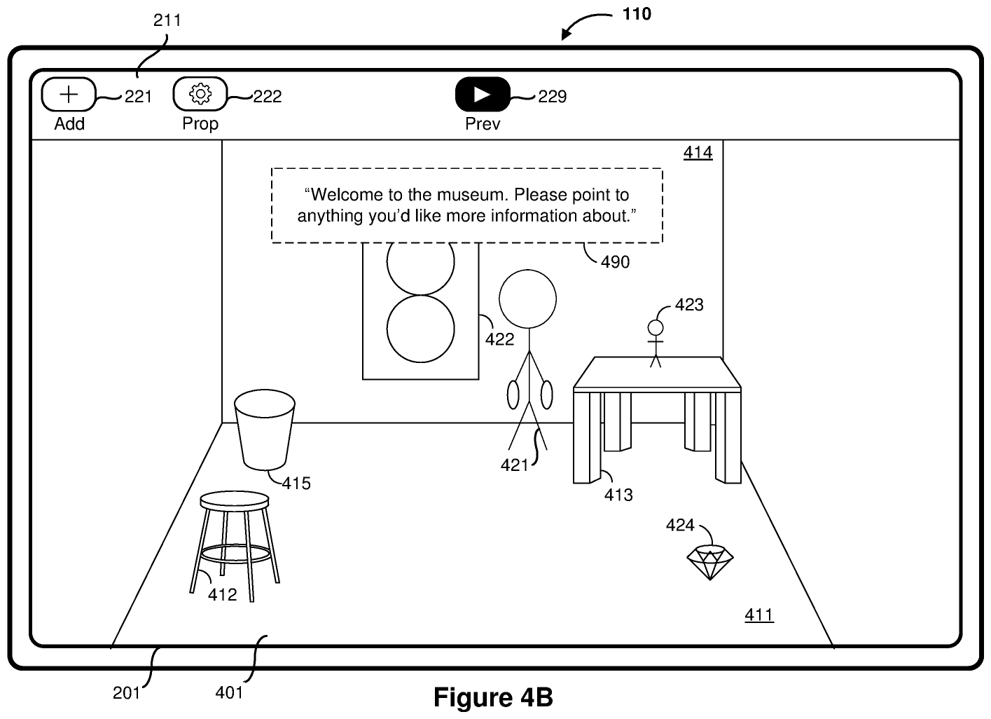

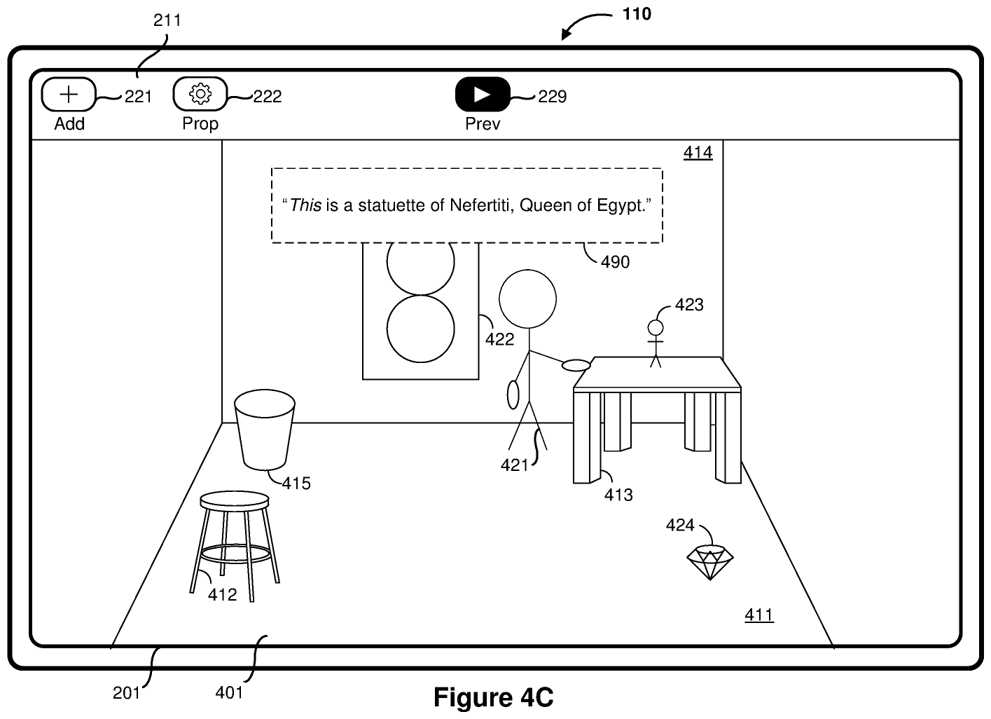

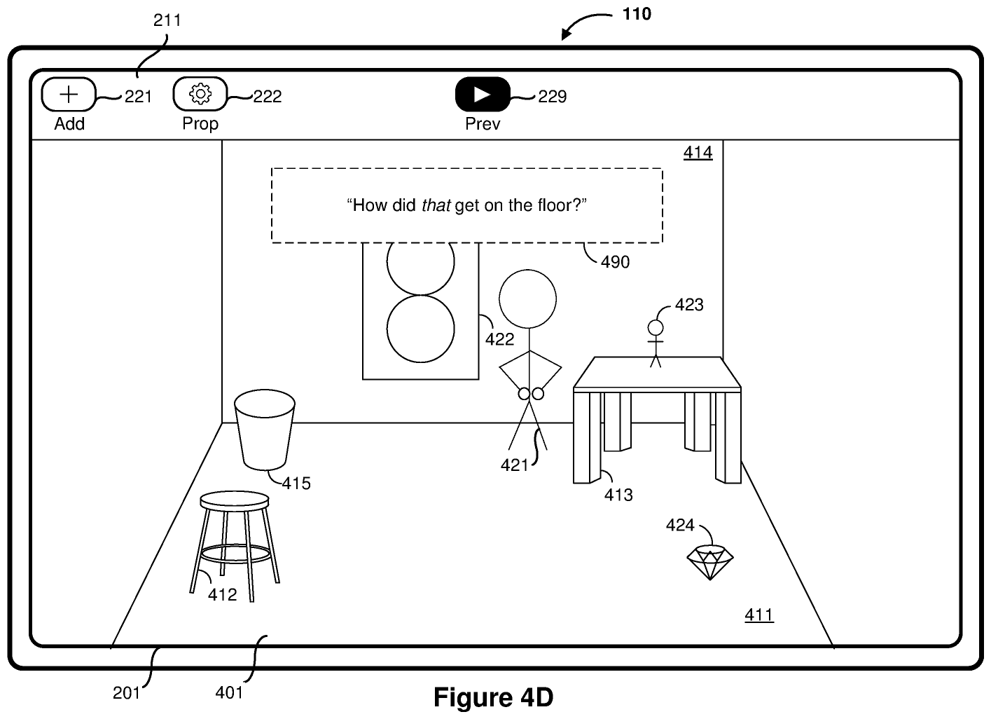

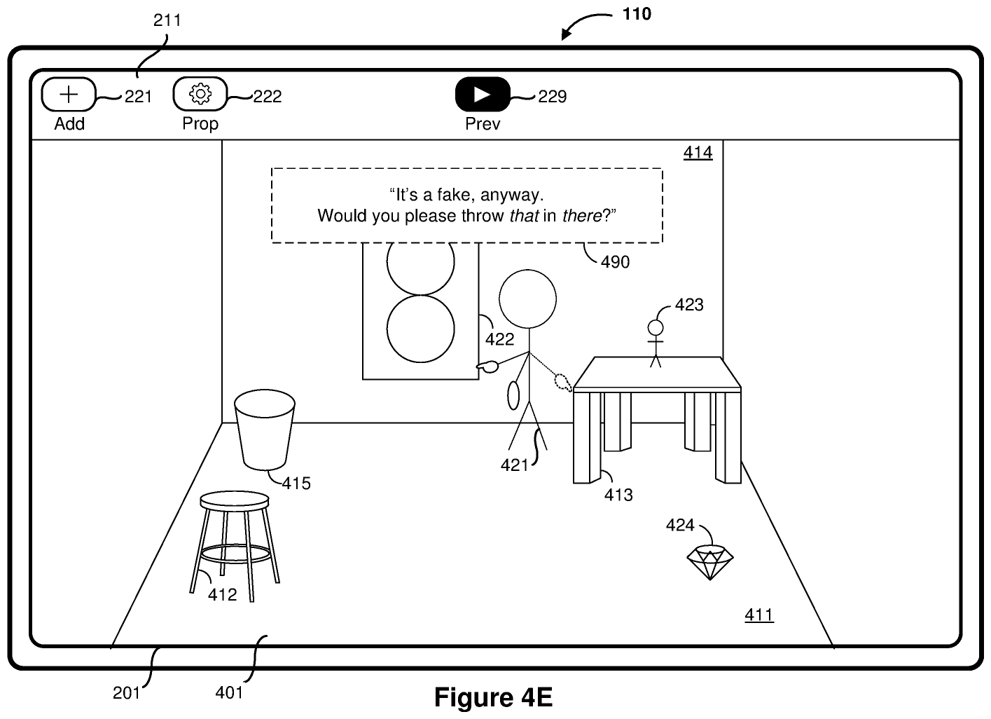

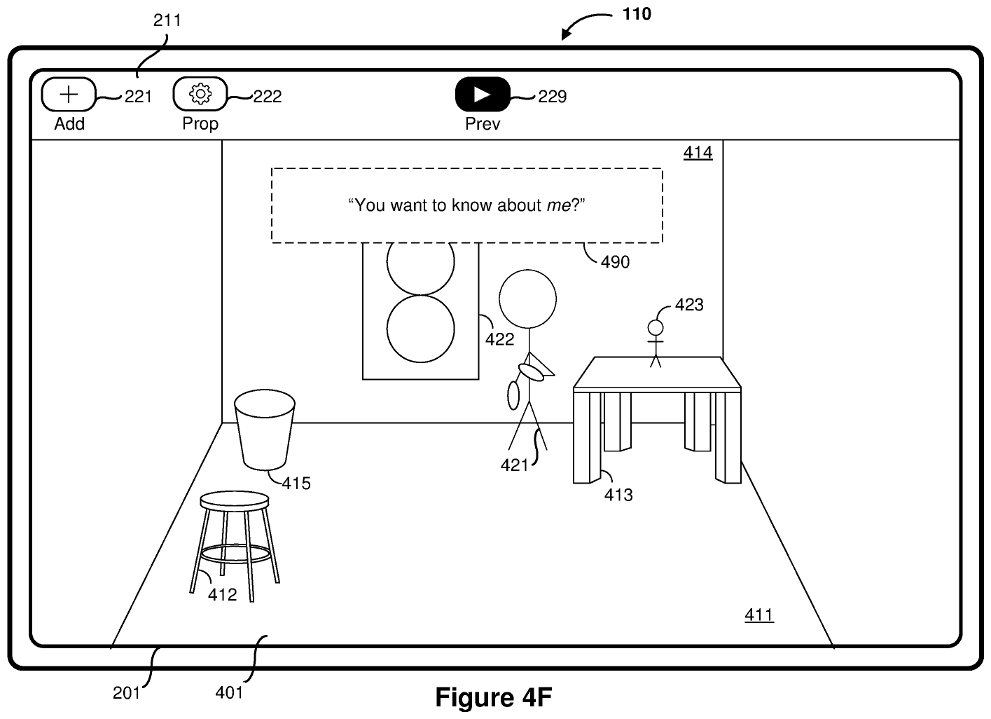

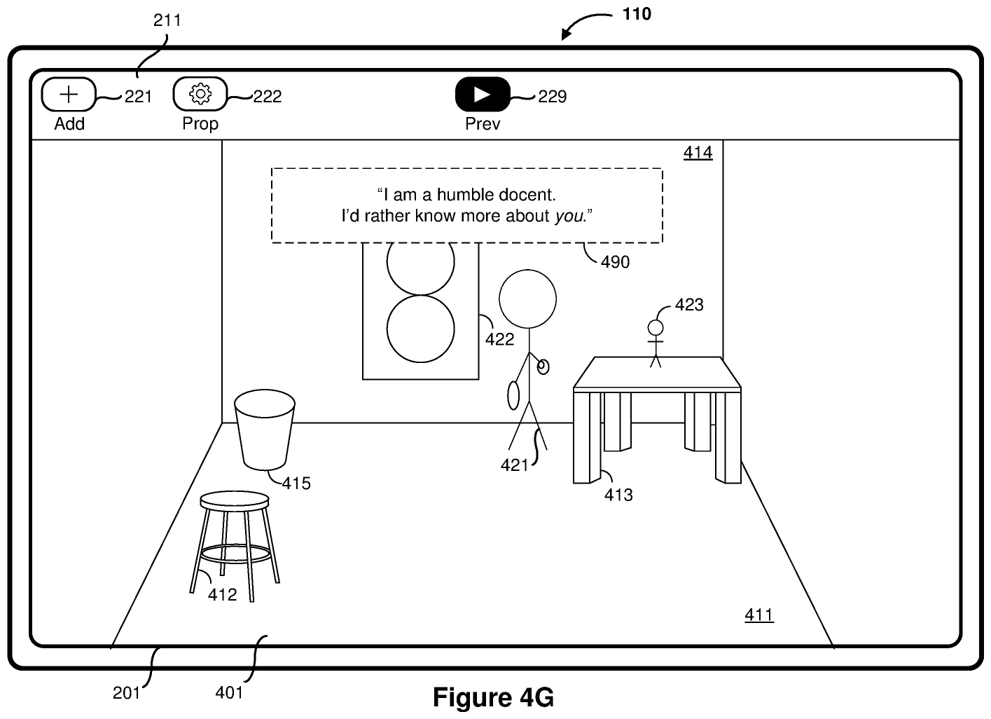

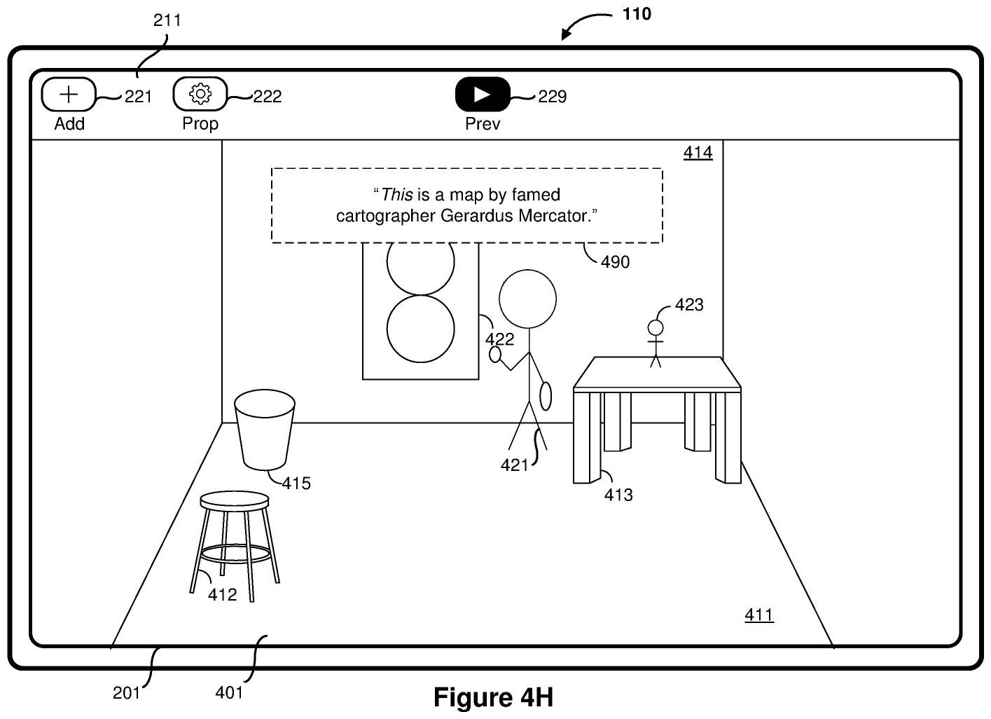

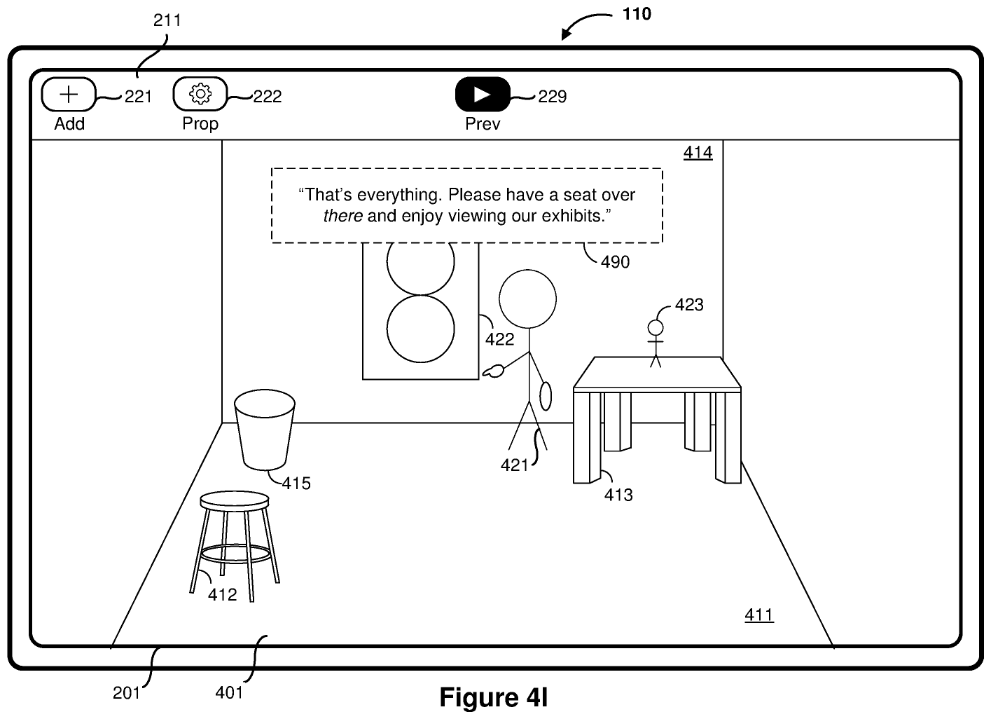

FIGS. 4A-4I illustrate a preview of the scene in a second physical environment in which the electronic device 110 is present. In various implementations, the preview of the scene is displayed in response to the user selecting the preview affordance 229 while in the second physical environment.

FIG. 4A illustrates the GUI 201 of FIG. 2F in response to detecting a user input directed to the preview affordance 229 while in a second physical environment. In FIG. 4A, the assets region 212 and the view region 213 are replaced with a preview region 401 providing a preview of the scene.

The second physical environment includes a physical tile floor, a physical stool, a physical table, a physical wall, and a physical garbage bin. Accordingly, the preview region 401 includes a representation of the second physical environment including a representation of the physical tile floor 411, a representation of the physical stool 412, a representation of the physical table 413, a representation of the physical wall 414, and a representation of the physical garbage bin 415.

In providing the preview of the scene, the electronic device 110 scans the second physical environment to determine whether the second physical environment includes objects that correspond to the anchor assets of the scene with the properties of the anchor assets. While doing so, the electronic device 110 displays a scanning notification 431.

In the second physical environment, the electronic device 110 determines that the physical tile floor corresponds to the anchor floor, that the physical wall is map-displayable and corresponds to the anchor vertical plane, that the top of the physical table has the appropriate size and location properties and corresponds to the second anchor horizontal plane, that the stool is user-sittable and corresponds to the first anchor horizontal plane, and that the physical garbage bin corresponds to the anchor trashcan.

FIG. 4B illustrates the GUI 201 of FIG. 4A in response to determining that the second physical environment includes an object that corresponds to each anchor asset of the scene with the properties of the physical asset.

In executing the scene, the preview region 401 includes the representation of the virtual map 422 displayed over the representation of the physical wall 414, the representation of the virtual docent character 421 displayed on the representation of the physical tile floor 411, a representation of the virtual statuette 423 on top of the representation of the physical table 413, and a representation of the virtual diamond 424 on top of the representation of the physical tile floor 411.

Further, the preview region 401 includes the virtual docent character giving the introductory speech. In various implementations, the preview region 401 includes a speech indicator 490 as a display-locked virtual object corresponding to audio produced by the electronic device 110. For example, at the time illustrated in FIG. 4B, the electronic device 110 produces the sound of the virtual docent character saying “Welcome to the museum. Please point to anything you′d like more information about,” e.g., the introductory speech. Although FIG. 4B (and FIGS. 4C-4I) illustrates the speech indicator 490 as a display-locked virtual object, in various implementations, the speech indicator 490 is not displayed while the audio is produced by the electronic device 110.

FIG. 4C illustrates the GUI of FIG. 4B in response to the user pointing at the representation of the virtual statuette 423. In FIG. 4C, the virtual docent character performs a deictic gesture indicating the representation of the virtual statuette 423, e.g., performing a showing gesture towards the representation of the virtual statuette 423. In FIG. 4C, the virtual docent character performs a speech regarding the virtual statuette. Accordingly, in FIG. 4C, the speech indicator 490 includes the phrase “This is a statuette of Nefertiti, Queen of Egypt.”

FIG. 4D illustrates the GUI of FIG. 4D in response to the user pointing at the representation of the virtual diamond 424. In FIG. 4D, the virtual docent character performs a consternation gesture directed at the representation of the virtual diamond 424. In FIG. 4D, the virtual docent character performs a speech regarding a location of the virtual diamond. Accordingly, in FIG. 3G, the speech indicator 490 includes the phrase “How did that get on the floor?”

FIG. 4E illustrates the GUI of FIG. 3D after the virtual docent character concludes performing the speech regarding the location of the virtual diamond. In FIG. 4E, the virtual docent character performs a deictic gesture indicating the representation of the virtual diamond 424 and the representation of the physical garbage bin 415, e.g., performing a pointing gesture at the representation of the virtual diamond 424 followed by a motion of the arm, without motion of the hand, to perform a pointing gesture at the representation of the physical garbage bin 415. In FIG. 4E, the virtual docent character performs a speech regarding the authenticity of the virtual diamond. Accordingly, in FIG. 4E, the speech indicator 490 includes the phrase “It's a fake, anyway. Would you please throw that in there?”

FIG. 4F illustrates the GUI 201 of FIG. 4E in response to the user pointing at the representation of the virtual docent character 421. In FIG. 4F, the virtual docent character performs a shock gesture including placing the virtual docent character's hand over the virtual docent character's heart. In FIG. 4F, the virtual docent character performs a speech expressing shock at being selected. Accordingly, in FIG. 4F, the speech indicator 490 includes the phrase “You want to know about me?”

FIG. 4G illustrates the GUI of FIG. 4F after the virtual docent character concludes performing the speech expressing shock at being selected. In FIG. 4G, the virtual docent character performs a deictic gesture indicating the user, e.g., performing a pointing gesture towards the user. In FIG. 4G, the virtual docent character performs a speech expressing interest in the user. Accordingly, in FIG. 4G, the speech indicator 490 includes the phrase “I am a humble docent. I'd rather know more about you.”

FIG. 4H illustrates the GUI 201 of FIG. 4G in response to the user pointing at the representation of the virtual map 422. In FIG. 4H, the virtual docent character performs a deictic gesture indicating the representation of the virtual map 422, e.g., performing a showing gesture at the representation of the virtual map 422. In FIG. 4H, the virtual docent character performs a speech regarding the virtual map. Accordingly, in FIG. 4H, the speech indicator 490 includes the phrase “This is a map by famed cartographer Gerardus Mercator.”

FIG. 4I illustrates the GUI of FIG. 4H in response to having performed the second action, the third action, and the fourth action. In FIG. 4I, the virtual docent character performs a deictic gesture indicating the representation of the physical stool 412, e.g., performing a pointing gesture at the representation of the physical stool 412. In FIG. 4I, the virtual docent character performs a speech inviting the user to sit. Accordingly, in FIG. 4I, the speech indicator 490 includes the phrase “That's everything. Please have a seat over there and enjoy viewing our exhibits.”

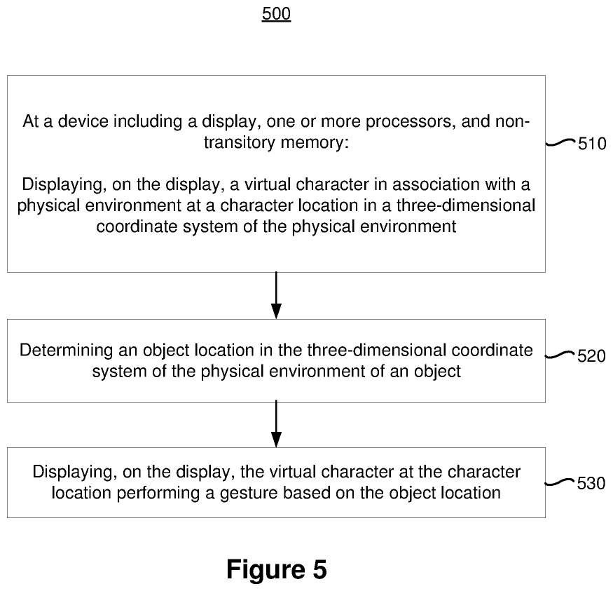

FIG. 5 is a flowchart representation of a method 500 of presenting a scene in accordance with some implementations. In various implementations, the method 500 is performed by a device with a display, one or more processors, and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device displaying, on the display, a virtual character in association with a physical environment at a character location in a three-dimensional coordinate system of the physical environment. For example, in FIG. 3B, the electronic device 110 displays, in the preview region 301, the representation of the virtual docent character 321 in association with the first physical environment at a location on the representation of the physical wood floor 311. As another example, in FIG. 4B, the electronic device 110 displays, in the preview region 401, the representation of the virtual docent character 421 in association with the second physical environment at a location on the representation of the physical tile floor 411.

In various implementations, the location includes one or more sets of three-dimensional coordinates in the three-dimensional coordinate system of the physical environment. For example, in various implementations, the location includes a single set of three-dimensional coordinates, such as a center or edge of the virtual character. As another example, in various implementations, the location includes a set of three-dimensional coordinates for each of a plurality of keypoints of the virtual character or each of a plurality of vertices of the virtual character.

In various implementations, displaying the virtual character includes mapping the location in the three-dimensional coordinate system of the physical environment to a location in a two-dimensional coordinate system of a display, e.g., by performing rasterization.

Although described herein for a virtual character in a physical environment, in various implementations, the method 500 is performed for a virtual character in a virtual environment.

The method 500 continues, in block 520, with the device determining, for an object, an object location in the three-dimensional coordinate system of the physical environment. In various implementations, the object is a virtual object displayed in association with the physical environment. For example, in FIG. 3C, the electronic device 110 determines an object location of the virtual map in order to display the representation of the virtual docent character 321 performing a pointing gesture at the representation of the virtual map 322. As another example, in FIG. 3F, the electronic device 110 determines an object location of the virtual statuette in order to display the representation of the virtual docent character 321 performing a pointing gesture at the representation of the virtual statuette 323. In various implementations, the object is a physical object in the physical environment. For example, in FIG. 3H, the electronic device 110 determines an object location of the physical wastebasket in order to display the representation of the virtual docent character 321 performing a pointing gesture at the representation of the physical wastebasket 315. As another example, in FIG. 3I, the electronic device 110 determines an object location of the physical couch in order to display the representation of the virtual docent character 321 performing a showing gesture toward the representation of the physical couch 312. In various implementations, the object is the device (or a user of the device). For example, in FIG. 3E, the electronic device 110 determines an object location of the electronic device 110 in order to display the representation of the virtual docent character 321 performing a showing gesture toward the user.

Thus, in various implementations, the gesture is further based on one or more characteristic of the user. In various implementations, the characteristics of the user include a location of the user. In various implementations, the characteristics of the user include at least one of an age or a height. In various implementations, the characteristics of the user include at least one of user preferences, user feedback, or user motion (e.g., to perform social mirroring).

The method 500 continues, in block 530, with the device displaying, on the display, the virtual character at the character location performing a gesture based on the object location. In various implementations, the gesture is a deictic gesture indicating the object at the object location. For example, in FIG. 3I, the electronic device 110 displays the representation of the virtual docent character 321 performing a deictic gesture indicating the representation of the physical couch 312. In various implementations, the gesture is a pointing gesture pointing at the object at the object location. For example, in FIG. 3F, the electronic device 110 displays the representation of the virtual docent character 321 performing a pointing gesture pointing at the representation of the virtual statuette 323. In various implementations, the method 500 further comprises determining, for a second object, a second object location in the three-dimensional coordinate system of the physical environment. In various implementations, displaying the virtual character performing the gesture is further based on the second object location. In various implementations, the gesture further indicates the second object at the second object location. For example, in FIG. 3H, the electronic device 110 displays the representation of the virtual docent character 321 performing a deictic gesture indicating the representation of the virtual diamond 324 and the representation of the physical wastebasket 315.

In various implementations, the gesture is based on a distance between the character location and the object location. For example, in FIG. 3F, the electronic device 110 displays the representation of the virtual docent character 321 performing a pointing gesture at the representation of the virtual statuette 323 based on a distance between the character location and the object location exceeding a threshold. In contrast, in FIG. 4C, the electronic device 110 displays the representation of the virtual docent character 421 performing a showing gesture toward the representation of the virtual statuette 423 based on a distance between the character location and the object location not exceeding the threshold.

In various implementations, the gesture is based on an orientation of the virtual character with respect to the object location. For example, in FIG. 3C, the electronic device 110 displays the representation of the virtual docent character 321 performing a pointing gesture at the representation of the virtual map 322 based on the object location being in front of the character location. In contrast, in FIG. 4H, the electronic device 110 displays the representation of the virtual docent character 421 performing a showing gesture toward the representation of the virtual map 422 based on the object location being behind the character location. In various implementations, the gesture is based on a visual knowledge of the virtual character. For example, if the object location is in the field-of-view of the virtual character, the virtual character performs a specific gesture (e.g., pointing at the object location), whereas if the object location is out of the field-of-view of the virtual character, the virtual character performs a vague gesture (e.g., back-handedly waving towards the general area of the object location).

In various implementations, the gesture is based on a size of the object location. For example, in FIG. 3I, the electronic device 110 displays the representation of the virtual docent character 321 performing a showing gesture towards the representation of the physical couch 312 based on the object location being greater than a threshold size. In contrast, in FIG. 4I, the electronic device 110 displays the representation of the virtual docent character 421 performing a pointing gesture at the representation of the physical stool 412 based on the object location being less than the threshold size.

In various implementations, the method 500 includes selecting a gesture type based on the object location. For example, in various implementations, the device selects a showing gesture or a pointing gesture based on a distance between the character location and the object location. Thus, in various implementations, the gesture is based on a gesture type, such as a showing gesture or a pointing gesture. In various implementations, the gesture is based on a gesture sub-type. For example, in various implementations, a pointing gesture is an imperative pointing gesture (e.g., to accompany a verbal command to “bring me that”) or an expressive pointing gesture (e.g., to accompany a verbal illustration that “that is my most prized possession”). As another example, in various implementations, a shrug gesture is an apathetic shrug gesture or a confused shrug gesture.

In various implementations, the method 500 includes generating the gesture based on the object location. In various implementations, the generating the gesture based on the object location includes determining, based on the object location, a plurality of keypoint locations in the three-dimensional coordinate system of the physical environment defining the gesture, wherein the plurality of keypoint locations includes, a keypoint location for each of a plurality of joints of the virtual character at each of a plurality of times. Further, displaying the virtual character performing the gesture includes displaying the plurality of joints at the plurality of keypoint locations at the plurality of times. For example, in various implementations, the gesture is a deictic gesture and, at a particular time, two or more of the keypoint locations (e.g., of two joints of the same finger) are collinear with the object location.

In various implementations, the gesture is further based on one or more characteristics of the virtual character. For example, in various implementations, in FIG. 3D, the electronic device 110 displays the representation of the virtual docent character 321 with the left hand of the virtual docent character over the heart of the virtual docent character based on a characteristic of the virtual docent character of left-handedness (rather than with the right hand over the heart based on a characteristic of right-handedness). As another example, in various implementations, in FIG. 3G, the electronic device 110 displays the representation of the virtual docent character 321 with the hands of the virtual docent character on the hips of the virtual docent character based on a characteristic of the virtual docent character of showiness (rather than simply a frown based on a characteristic of modesty). In various implementations, the characteristics of the virtual character includes at least one of a handedness, personality, an emotion, a height, a velocity, or a spatial extent.

In various implementations, the method 500 further comprises detecting a trigger and displaying the virtual character performing the gesture is performed in response to detecting the trigger. In various implementations, the trigger is a user input. In various implementations, the trigger is the user performing a gesture indicating the object. For example, in FIG. 3C, the electronic device 110 displays the representation of the virtual docent character 321 performing a pointing gesture at the representation of the virtual map 322 in response to the user pointing at the representation of the virtual map 322.

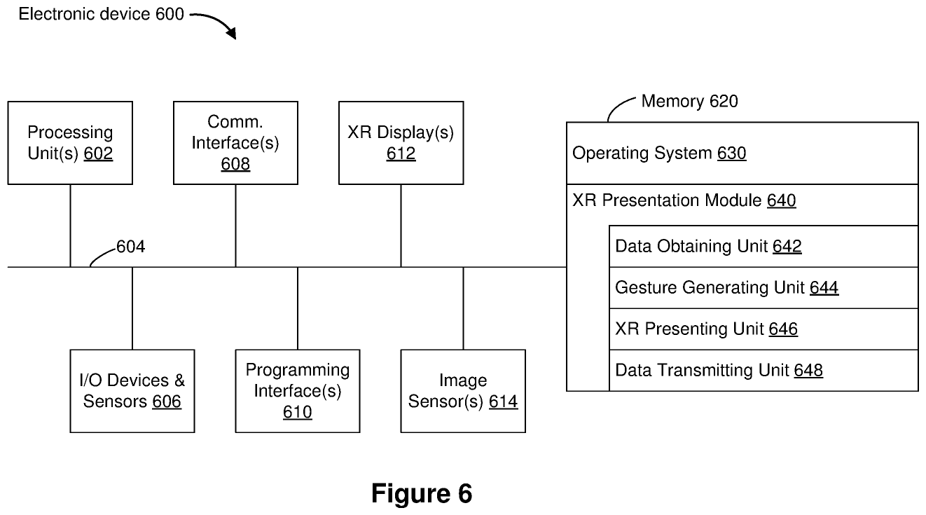

FIG. 6 is a block diagram of an electronic device 600 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior- and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to present XR content to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 600 includes a single XR display. In another example, the electronic device 600 includes an XR display for each eye of the user. In some implementations, the one or more XR displays 612 are capable of presenting AR, MR, and/or VR content.

In various implementations, the one or more XR displays 612 are video passthrough displays which display at least a portion of a physical environment as an image captured by a scene camera. In various implementations, the one or more XR displays 612 are optical see-through displays which are at least partially transparent and pass light emitted by or reflected off the physical environment.

In some implementations, the one or more image sensors 614 are configured to obtain image data that corresponds to at least a portion of the face of the user that includes the eyes of the user (and may be referred to as an eye-tracking camera). In some implementations, the one or more image sensors 614 are configured to be forward-facing so as to obtain image data that corresponds to the scene as would be viewed by the user if the electronic device 610 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a gesture generating unit 644, an XR presenting unit 646, and a data transmitting unit 648.

In some implementations, the data obtaining unit 642 is configured to obtain data (e.g., presentation data, interaction data, sensor data, location data, etc.). The data may be obtained from the one or more processing units 602 or another electronic device. To that end, in various implementations, the data obtaining unit 642 includes instructions and/or logic therefor, and heuristics and metadata therefor.

In some implementations, the gesture generating unit 644 is configured to generate a gesture for a virtual character at a character location based on an object location of an object. To that end, in various implementations, the gesture generating unit 644 includes instructions and/or logic therefor, and heuristics and metadata therefor.

In some implementations, the XR presenting unit 646 is configured to present XR content via the one or more XR displays 612. For example, in various implementations, the XR presenting unit 646 is configured to execute a scene in association with a physical environment. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to the one or more processing units 602, the memory 620, or another electronic device. To that end, in various implementations, the data transmitting unit 648 includes instructions and/or logic therefor, and heuristics and metadata therefor.

Although the data obtaining unit 642, the gesture generating unit 644, the XR presenting unit 646, and the data transmitting unit 648 are shown as residing on a single electronic device 600, it should be understood that in other implementations, any combination of the data obtaining unit 642, the gesture generating unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and non-transitory memory;
displaying, on the display, a virtual character in association with a physical environment at a character location in a three-dimensional coordinate system of the physical environment;
determining, for an object, an object location in the three-dimensional coordinate system of the physical environment; and
displaying, on the display, the virtual character at the character location performing a gesture based on the object location.

2. The method of claim 1, wherein the object is a virtual object displayed in association with the physical environment.

3. The method of claim 1, wherein the object is a physical object in the physical environment.

4. The method of claim 3, wherein the object is the device.

5. The method of claim 1, wherein the gesture is a deictic gesture indicating the object at the object location.

6. The method of claim 5, wherein the gesture is a pointing gesture pointing at the object at the object location.

7. The method of claim 5, further comprising determining, for a second object, a second object location in the three-dimensional coordinate system of the physical environment of the second object, wherein displaying the virtual character performing the gesture is further based on the second object location, wherein the gesture further indicates the second object at the second object location.

8. The method of claim 1, wherein the gesture is based on a distance between the character location and the object location.

9. The method of claim 1, wherein the gesture is based on an orientation of the virtual character with respect to the object location.

10. The method of claim 9, wherein the gesture is based on a field-of-view of the virtual character.

11. The method of claim 1, wherein the gesture is a based on a size of the object location.

12. The method of claim 1, further comprising determining, based on the object location, a plurality of keypoint locations for each of a plurality of joints of the virtual character at each of a plurality of times, wherein displaying the virtual character performing the gesture includes displaying the plurality of joints at the plurality of keypoint locations at the plurality of times.

13. The method of claim 1, wherein the gesture is further based on one or more characteristics of the virtual character.

14. The method of claim 1, further comprising detecting a trigger, wherein displaying the virtual character performing the gesture is performed in response to detecting the trigger.

15. The method of claim 14, wherein the trigger is a user input.

16. The method of claim 14, wherein the trigger is the user performing a gesture indicating the object.

17. A device comprising:
a display;
a non-transitory memory; and
one or more processors to:
display, on the display, a virtual character in association with a physical environment at a character location in a three-dimensional coordinate system of the physical environment;
determine, for an object, an object location in the three-dimensional coordinate system of the physical environment; and
display, on the display, the virtual character at the character location performing a gesture based on the object location.

18. The device of claim 17, wherein the gesture is a deictic gesture indicating the object at the object location.

19. The device of claim 17, wherein the one or more processors are further to determine, based on the object location, a plurality of keypoint locations for each of a plurality of joints of the virtual character at each of a plurality of times, wherein the one or more processors are to display the virtual character performing the gesture by displaying the plurality of joints at the plurality of keypoint locations at the plurality of times.

20. A non-transitory memory storing one or more programs, which, when executed by one or more processors of a device including a display, cause the device to:
display, on the display, a virtual character in association with a physical environment at a character location in a three-dimensional coordinate system of the physical environment;
determine, for an object, an object location in the three-dimensional coordinate system of the physical environment; and
display, on the display, the virtual character at the character location performing a gesture based on the object location.
